(19) United States
(12) Patent Application Publication
(10) Pub. No.: US 2006/0004672 A1
(43) Pub. Date: Jan. 5, 2006

(54) Prepaid billing apparatus and method for printing systems

(75) Inventor: Gerardo Leute, Penfield, NY (US)

Correspondence Address: John S. Zanghi, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/881,463

(22) Filed: Jun. 30, 2004

(51) Int. Cl. G06F 17/60

(52) U.S. Cl. 705/66

(57) ABSTRACT

A method of providing prepaid billing by receiving a request for a recharge token from a customer; accepting payment information and the number of additional prints requested from the customer; receiving from the customer a unique serial number for the printing system, a current copy count for the printing system, and a remaining copy count for the printing system; generating a recharge token; encrypting the recharge token according to an encryption key stored in a first database; transmitting the encrypted recharge token to the customer; storing the encrypted recharge token in a second database; decoding the encrypted recharge token according to an encryption key stored in the second database; determining whether the decoded recharge token is valid; and where the decoded recharge token is valid, increasing the remaining copy count by the number of additional prints requested.

### BACKGROUND

The present exemplary embodiment relates generally to printing systems. It finds particular application in conjunction with digital copiers, printers and multifunction printing machines that can output prints based on either digital data received from a computer, or from image data derived from the scanning of a hard copy original. However, it is to be appreciated that the present exemplary embodiment is also amenable to other like applications.

A recent trend in the office equipment industry is to provide “multi-function” devices, in which the functions of a copier and printer, and sometimes a facsimile machine and digital scanner as well, are combined in a unified architecture. In the basic case of a combined copier-printer, such a machine operates as a typical printer, in that digital image data, such as originating in a computer, can be submitted to the apparatus, and result in the output of print sheets based on the digital data. In addition, hard-copy originals can be placed in a document handler and then scanned, so that the images on the hard-copy originals are exposed onto one or more photosensitive chips to yield a quantity of digital image data. This digital image data based on the scanned hard-copy originals can then be submitted to the same printing hardware at which the print jobs are output. Thus, in a copier-printer, a single set of printing hardware is shared by a printing apparatus and a copier. If a facsimile function is added, incoming faxes are printed on the same printing hardware, and the digital scanner can be used for scanning outgoing faxes.

Nonetheless, costs for maintenance and consumables, such as toner, can be substantial and fluctuate greatly over the course of any given year. Thus, there is an uncertainty associated with variable office equipment related charges. Accordingly, there is a need for an apparatus and method that would allow customers to pre-pay for a certain quantity of prints, effectively paying a price that would cover all aspects of equipment maintenance and consumables. This would allow customers to limit their expenditures on office equipment-related expenses, as necessary. The customers could, in effect, give themselves a fixed budget of prints. Customers would have the flexibility of increasing the number of allocated prints at any time by purchasing additional print credits.

### BRIEF DESCRIPTION

In accordance with one aspect of the present exemplary embodiment, there is provided a method of providing prepaid billing for a printing system. The method includes receiving a request for a recharge token from a customer; accepting payment information and the number of additional prints requested from the customer; receiving from the customer a unique serial number for the printing system, a current copy count for the printing system, and a remaining copy count for the printing system; generating a recharge token; encrypting the recharge token according to an encryption key stored in a first database; transmitting the encrypted recharge token to the customer; storing the encrypted recharge token in a second database; decoding the encrypted recharge token according to an encryption key stored in the second database; determining whether the decoded recharge token is valid; and where the decoded recharge token is valid, increasing the remaining copy count by the number of additional prints requested.

In accordance with another aspect of the present exemplary embodiment, there is provided an apparatus for providing prepaid billing for a printing system. The apparatus includes receiving means for receiving a request for a recharge token from a customer; accepting means for accepting payment information and the number of additional prints requested from the customer; receiving means for receiving from the customer a unique serial number for the printing system, a current copy count for the printing system, and a remaining copy count for the printing system; generating means for generating a recharge token; encrypting means for encrypting the recharge token according to an encryption key stored in a first database; transmitting means for transmitting the encrypted recharge token to the customer; storing means for storing the encrypted recharge token in a second database; decoding means for decoding the encrypted recharge token according to an encryption key stored in the second database; determining means for determining whether the decoded recharge token is valid; and increasing means for increasing the remaining copy count by the number of additional prints requested, where the decoded recharge token is valid.

In accordance with yet another aspect of the present exemplary embodiment, there is provided a prepaid billing system comprising a printing system and a service provider. The printing system includes a user interface; a first database for storing an encrypted recharge token and a unique serial number, a current copy count, and a remaining copy count; and a first CPU for decoding the encrypted recharge token according to an encryption key stored in the first database and for determining whether the decoded recharge token is valid. The service provider includes a network interface for receiving a request for a recharge token from a customer, accepting payment information and the number of additional prints requested from the customer, and receiving printing system data from the customer; a second database for storing an encryption key; and a second CPU for generating a recharge token and encrypting the recharge token according to the encryption key.

### BRIEF DESCRIPTION OF THE DRAWINGS

FIG. 1 is a block diagram showing a prepaid billing system suitable for implementing aspects of the present exemplary embodiment.

FIG. 2 is flow diagram illustrating the essential elements of a method of prepaid billing for copying and printing.

FIG. 3 is a flow diagram illustrating an example of the prepaid billing method with screens according to aspects of the present exemplary embodiment.

### DETAILED DESCRIPTION

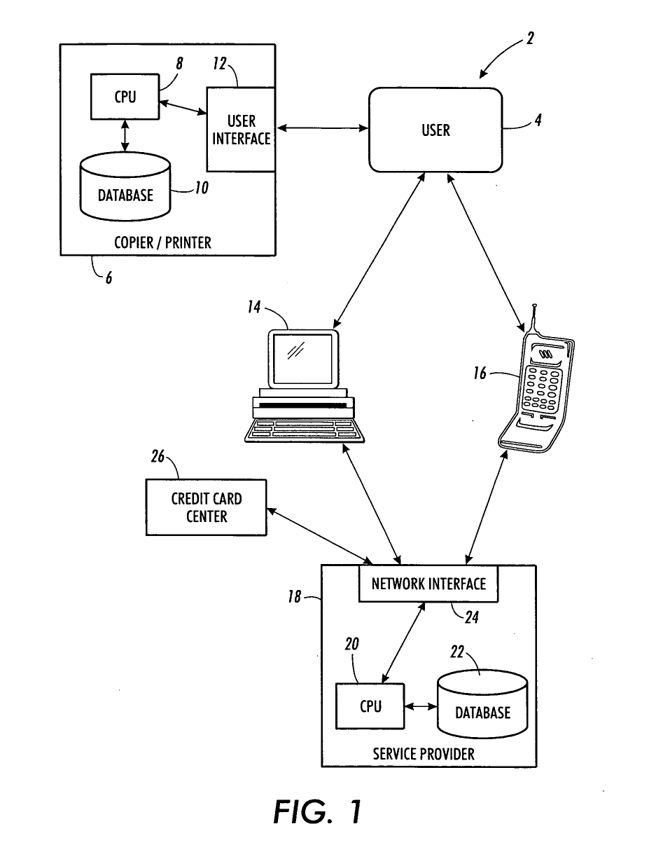

There is shown in FIG. 1 a prepaid billing system 2 suitable for implementing aspects of the present exemplary embodiment. The system 2 includes an operator or user 4 and a printing system 6 for printing and/or copying documents. The printing system 6 may be a standard digital copier, digital printer or multifunction printing machine that can output prints based on either digital data received from a computer, or from image data derived from the scanning of a hard copy original. The printing system 6 is able to provide pre-paid billing service in the manner described below, and preferably includes a CPU 8, such as a microprocessor, for controlling the hardware in the printing system 6, a database 10 for storing data relating to the printing system 6, and a user interface 12.

The user interface 12 between the printing system 6 and the operator or user 4, in essence, permits dialogue between operator and machine. A suitable user interface 12 provides the controls, displays, and messages necessary to activate, program, monitor, and maintain the printing system 6. As disclosed in U.S. Pat. No. 5,061,958 to Bunker et al and U.S. Pat. No. 5,604,860 to McLaughlin et al., for example, the user interface 12 may contain a wide range of information impacting the functionality of the corresponding printing system 6. Most significantly, the user interface 12 permits the user 4 to provide the printing system 6 with control information, such as suitable values for attributes. That is, the user 4 typically provides control instructions for parameters associated with everything ranging from image processing to finishing characteristics. As disclosed in the above-mentioned patents, many dialogs may be required to sufficiently program the control instructions for the corresponding printing system 6.

Preferably, the user 4 has access to a computing device 14 with Internet access, such as a personal computer, a notebook computer or a PDA and/or to a communication device 16, such as a standard landline telephone or a mobile phone. The computing device 14 and the communication device are to be used for connecting to a service provider 18, such as Xerox Corporation of Stamford, Conn. It is to be understood, however, that the printing system 6 may also be connected directly to the service provider 18 through a suitable communication link (not shown) as known to those skilled in the art. Also, the user 4 preferably has a means of payment, such as a credit card that is issued by a credit company or a debit card that is issued by a bank.

The service provider 18 may provide the printing system 6 to the user 4 and/or any necessary consumables that may be associated with printing documents, such as toner, drum or fuser cartridges, or other parts. In addition, the service provider 18 may provide repair and maintenance service for the printing system 6. The service provider 18 will include a CPU 20 such as a microprocessor or a secure server, a database 22 for storing data concerning the pre-paid billing program, among other things, and a network interface 24 for communicating with customers. The processing functions to be accomplished are described in a program and recorded in a computer-readable recording medium so that by executing the program by the CPU 20, the above-described processing can be executed. In this regard, the CPU 20 preferably includes memory (not shown), for example, a hard disk, a dynamic random access memory (DRAM), a read-only memory (ROM), etc. for storing the necessary computer code. The CPU 20 executes the computer code necessary for implementing the prepaid billing method described in greater detail below.

The service provider 18 is connected on-line to a credit card center 26 through a public telephone circuit, and the credit center 26 is connected to a bank on-line (not shown), in which bank the user 4 has an account.

The printing system 6 may be purchased via any known means, such as through retail or telemarketing. Preferably, each printing system 6 has a unique serial number (SN), an internally stored encryption key, and a non-resettable “current copy count” (CCC). The serial number (e.g., 456) is indexed with the encryption key of the printing system 6, stored by the service provider 18, and accessed when the user 4 requests recharge tokens. The serial number is used to encrypt the recharge token. When purchased new, the printing system 6 comes with a number of authorized prints included, such as 500. The “remaining copy count” (RCC) is set to this figure. The remaining copy count is decreased for each print/copy made. When the printing system 6 runs low on remaining authorized prints/copies, it displays a message indicating this to the user 4. The printing system 6 also displays the serial number, current copy count, and remaining copy count via the display unit of the user interface 12. When the remaining copy count reaches zero, the printing system 6 stops making copies/prints.

When the printing system 6 runs low on remaining authorized prints/copies, it preferably displays a message on the user interface 12 indicating this to the user 4. The printing system 6 would display the serial number, current copy count, and remaining copy count. At this point, the user 4 needs to recharge the system.

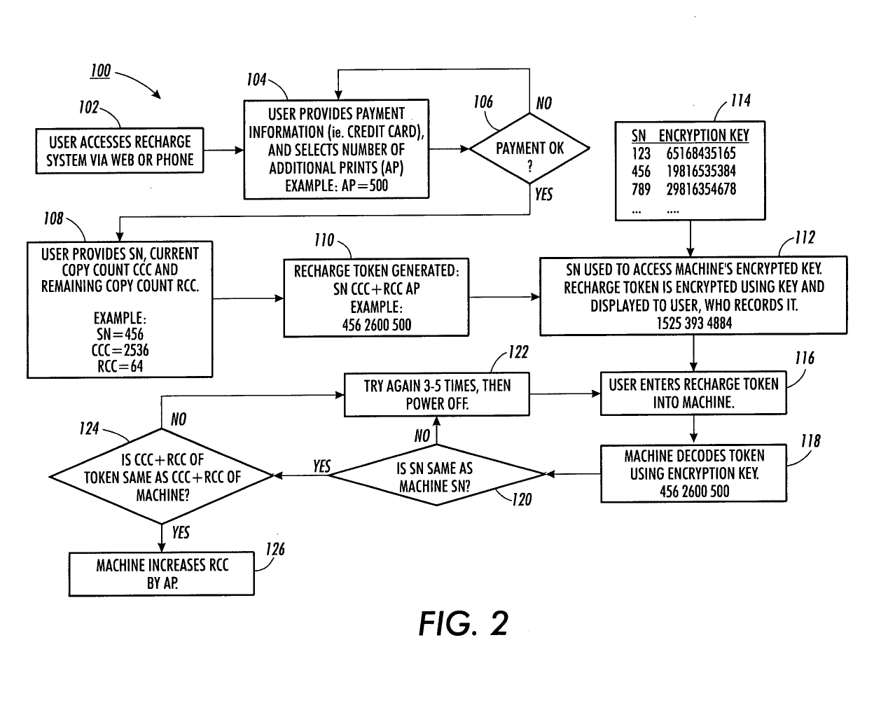

FIG. 2 is a flow chart illustrating a method of prepaid billing for printing systems. Initially, in step 102, the user 4 accesses the recharge system of the service provider 18. This access may be accomplished via the computer 14 or the communication device 16. Next, the user 4 provides payment information (e.g., credit card information) and selects the number of “additional prints” (AP) (step 104). For example, the user 4 may desire 500 additional prints. Next, a determination is made as to whether payment is satisfied (step 106). This may be accomplished by the service provider 18 through the credit card center 26. If not, then the user 4 reenters payment information as in step 104. Otherwise, the user 4 provides the serial number, the current copy count, and the remaining copy count, all via the user interface (step 108). Next, the recharge token, which consists of the serial number, the current copy count plus the remaining copy count, and the additional prints (SN CCC+RCC AP) is generated (step 110). Thus, in this example, the recharge token would be 456 2600 500.

The serial number is used to access the encryption key of the printing system 6 (step 112). The database stores a look-up table 114. The recharge token is encrypted using the key. For example, a large number is permanently associated with each serial number as its key. In this example, the number 19816535384 is associated with SN 456. The recharge token (SN CCC+RCC AP) is concatenated into one number, where 456 2600 500 becomes 4562600500. This number is then mathematically subtracted from the key associated with each serial number, resulting in the encrypted recharge token 15253934884. The encrypted recharge token is provided to the user 4, who preferably records it. It is to be understood, however, that this is only one way of generating the recharge token. Any encryption technique may be used to encrypt the recharge token. These techniques are well known in the art and will not be described further.

The user 4 then enters the recharge token via the user interface 12 (step 116). The printing system 6, through the CPU 8, decodes the recharge token using the encryption key, which is stored in the database 10 (step 118). Next, a determination is made as to whether the serial number in the decoded recharge token is the same as the serial number of the printing system 6 (step 120). If not, then the printing system tries again for a certain number of times (step 122), i.e., steps 116, 118, and 120 may be repeated for a set number of times, such as three to five times. If still unsuccessful, the printing system 6 powers off. This deters attempts to try random token figures or tokens intended for other machines.

If the serial numbers do match, however, then a determination is made as to whether the second number associated with the token (CCC+RCC) is the same as the second number (CCC+RCC) of the printing system 6 (step 124). If so, then the printing system 6 increases the remaining copy count by the additional prints (step 126). Otherwise, steps 116, 118, and 120 may be repeated for a set number of times, such as three to five times. This deters attempts to re-use a recharge token.

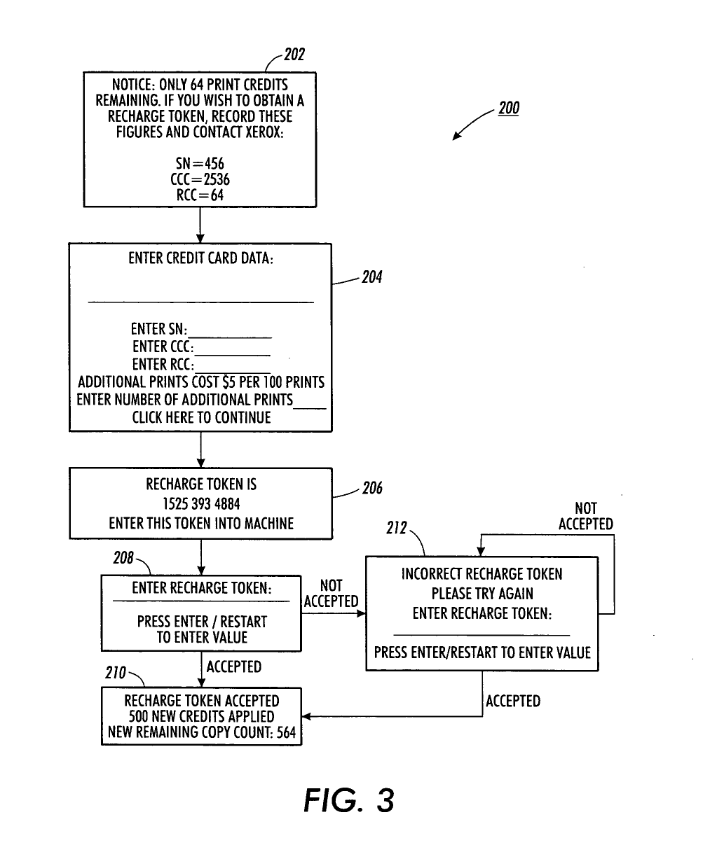

FIG. 3 is a flow diagram illustrating a sequence of screen displays the user 4 may see on the user interface 12 during the recharging process above. Initially, the user 4 may receive a notice that only a given number of print credits are remaining (202). The number of print credits that may trigger the notice may be set by the user 4 through the user interface 12 and then stored in the database 10. For example, the user 4 may wish to receive such a notice whenever the remaining copy count is below 100. The user 4 would also receive instructions to contact the service provider 18, e.g., Xerox, for more credits. Also, the serial number, the current copy count, and the remaining copy count would be provided to the user 4.

The printing system 6 may have a direct communication link to the service provider 18. In that case, the user 4 would have an opportunity to enter credit card data as well as the serial number, current copy count, and the remaining copy count (204). The user 4 would also enter the number of additional prints desired. The user interface 12 would then display the recharge token (206). However, if the printing system 6 did not have a direct communication link to the service provider, then the user 4 would use the computer 14 or the telephone 16 to obtain a recharge token in the manner described earlier.

Next, the user 4 would be instructed to enter the recharge token (208). If the recharge token was accepted, then the requested number of additional prints (or new credits) would be applied and the new remaining copy count displayed (210). Otherwise, the user 4 would be notified that the recharge token was incorrect, and instructed to reenter the recharge token (212).

The exemplary embodiment has been described with reference to preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of providing prepaid billing for a printing system, the method comprising:
receiving a request for a recharge token from a customer;
accepting payment information and the number of additional prints requested from the customer;
receiving from the customer a unique serial number for the printing system, a current copy count for the printing system, and a remaining copy count for the printing system;
generating a recharge token;
encrypting the recharge token according to an encryption key stored in a first database;
transmitting the encrypted recharge token to the customer;
storing the encrypted recharge token in a second database;
decoding the encrypted recharge token according to an encryption key stored in the second database;
determining whether the decoded recharge token is valid; and
where the decoded recharge token is valid, increasing the remaining copy count by the number of additional prints requested.

2. The method defined in claim 1, further comprising verifying the customer's payment information with a third party.

3. The method defined in claim 1, wherein the customer's request for a recharge token is made via the Internet.

4. The method defined in claim 1, wherein the customer's request for a recharge token is made via telephone.

5. The method defined in claim 1, wherein the recharge token comprises the serial number, the current copy count plus the remaining copy count, and the number of additional prints.

6. The method defined in claim 1, further comprising:
indexing the serial number of the printing system with the encryption key stored in the first database.

7. The method defined in claim 1, wherein encrypting the recharge token includes:
associating a first number with each serial number;
concatenating the recharge token into a second number; and
subtracting the second number from the first number.

8. The method defined in claim 5, further comprising:
indexing the serial number of the printing system with the encryption key stored in the first database.

9. The method defined in claim 8, wherein encrypting the recharge token includes:
associating a first number with each serial number;
concatenating the recharge token into a second number; and
subtracting the second number from the first number.

10. An apparatus for providing prepaid billing for a printing system, the apparatus comprising:
receiving means for receiving a request for a recharge token from a customer;
accepting means for accepting payment information and the number of additional prints requested from the customer;
receiving means for receiving from the customer a unique serial number for the printing system, a current copy count for the printing system, and a remaining copy count for the printing system;
generating means for generating a recharge token;
encrypting means for encrypting the recharge token according to an encryption key stored in a first database;
transmitting means for transmitting the encrypted recharge token to the customer;
storing means for storing the encrypted recharge token in a second database;
decoding means for decoding the encrypted recharge token according to an encryption key stored in the second database;
determining means for determining whether the decoded recharge token is valid; and
increasing means for increasing the remaining copy count by the number of additional prints requested, where the decoded recharge token is valid.

11. The apparatus defined in claim 10, further comprising verifying means for verifying the customer's payment information with a third party.

12. The apparatus defined in claim 10, wherein the customer's request for a recharge token is made via the Internet.

13. The apparatus defined in claim 10, wherein the customer's request for a recharge token is made via telephone.

14. The apparatus defined in claim 10, wherein the recharge token comprises the serial number, the current copy count plus the remaining copy count, and the number of additional prints.

15. The apparatus defined in claim 10, further comprising indexing means for indexing the serial number of the printing system with the encryption key stored in the first database.

16. The apparatus defined in claim 10, wherein encrypting the recharge token includes:
associating means for associating a first number with each serial number;
concatenating means for concatenating the recharge token into a second number; and
subtracting means for subtracting the second number from the first number.

17. The apparatus defined in claim 14, further comprising indexing means for indexing the serial number of the printing system with the encryption key stored in the first database.

18. The apparatus defined in claim 17, wherein encrypting the recharge token includes:
associating means for associating a first number with each serial number;
concatenating means for concatenating the recharge token into a second number; and
subtracting means for subtracting the second number from the first number.

19. A prepaid billing system comprising:
a printing system and a service provider;
wherein the printing system includes:
a user interface;
a first database for storing an encrypted recharge token and a unique serial number, a current copy count, and a remaining copy count; and
a first CPU for decoding the encrypted recharge token according to an encryption key stored in the first database and for determining whether the decoded recharge token is valid; and
wherein the service provider includes:
a network interface for receiving a request for a recharge token from a customer, accepting payment information and the number of additional prints requested from the customer, and receiving printing system data from the customer;
a second database for storing an encryption key; and
a second CPU for generating a recharge token and encrypting the recharge token according to the encryption key.

20. The system defined in claim 19, wherein the recharge token comprises the serial number, the current copy count plus the remaining copy count, and the number of additional prints requested by the customer.
